(19) United States
(12) Patent Application Publication
(10) Pub. No.: US 2009/0279291 A1
(43) Pub. Date: Nov. 12, 2009

(54) PORTABLE FLEXIBLE ILLUMINATING DEVICE

(76) Inventor: Brian D. Vieira, Fall River, MA (US)

Correspondence Address: LAW OFFICE OF BRETT N. DORNY, 386 WEST MAIN STREET, SUITE 12A, NORTHBOROUGH, MA, 01532, US

(21) Appl. No.: 12/117,133

(22) Filed: May 8, 2008

(51) Int. Cl. F21L 4/04

(52) U.S. Cl. 362/198

(57) ABSTRACT

A portable illumination device includes a body, a flexible extension and an plurality of interchangeable illumination elements. The flexible extension may be formed from one piece or multiple pieces assembled together. The illumination element is selected from a set of different types of interchangeable illumination elements. The body houses a power source which transmits power through the flexible extension to the illumination element. Different types of mounting brackets may be attached to either the body or extension for securing the portable illumination device. Several different illumination elements and several different extension pieces may be packaged together forming a portable illumination device kit.

### BACKGROUND OF THE INVENTION

1. Field of the Invention

The present invention relates generally to portable illuminating devices. More particularly, the present invention relates to mountable portable illuminating devices having flexible positioning, interchangeable illumination elements of various sizes and types.

2. Description of the Related Art

Proper illumination helps improve the repair process for mechanical devices such as: automobiles, farm equipment, lawn mowers, snow blowers, snow machines, or other types of power equipment. For example, a mechanic may need to see the position of a bolt while maneuvering a wrench into position or may need to see the type or size of a bolt. A mechanic may also need to see whether a bolt is really moving as force is applied. In addition, a mechanic may need to see whether a part is worn, dirty, or bent. All these tasks and others require that the area of interest be properly illuminated.

Often points of repair are hidden in dark and hard to reach places. Thus, illuminating a point of repair may be difficult. The distances from the point of access to the point of repair may greatly vary. A route from the point of access to the point of repair may require negotiating around several different points of varying sized openings. A point of repair may be dark. Thus, illuminating devices which are portable, extendable, and physically flexible are useful.

Another issue, which may affect properly illumination, includes the size and type of surface near the point of repair. The surface near the point of repair may be such that an illuminating device must be mounted to insure stability.

Yet, another issue, a light or illumination source which oscillates may distract the mechanic. Thus, motionless illumination is desirable. A motionless illumination source enables a mechanic to work with more focus.

Still yet, the type and brightness of illuminating devices may be important. An illuminating device with proper intensity, neither too bright nor too dim improves the mechanics ability to see clearly, the necessary detail. Mechanics may prefer a particular type of illumination for a particular repair. Providing illuminating devices with different types of illumination elements is advantageous.

Finally, repairs often require two hands. For example, bolting together parts or checking fluid levels generally requires two hands. A local mountable illumination device is advantageous, because it allows a mechanic the flexibility of using both hands.

Known illuminating devices used during repairs include several different types such as: overhead house lights, treble lights, and portable illuminating devices. Some portable illuminating devices such as flashlights have been used. Generally, portable illuminating devices are comprised of a body, an extension, and an illumination element. The power source for portable illuminating devices, though generally batteries located in the body, may also be located in the illuminating element. An illuminating element generally includes: housing with a lens, and a light source. Various types of portable illuminating devices are known.

One such device comprises a flat bottom body with multiple elongated, flexible, fixed length extensions. An LED connects at the end of each fixed length extension. The LEDs are electrically attached through the extensions to a battery power source located within the body. The device does not permit multiple types of illumination elements. It is also limited by the fixed length of each flexible extension.

Another such device comprises a free standing body with a battery power source. The lamp assembly and flat bottom body connect through an extension comprised of a rigid set of extendable rods. The device does not permit multiple types of illumination elements.

Yet, another such device comprises a hand held body with a battery power supply, a flexible extension, a lamp assembly, and a lamp assembly storage clamp. The device does not permit multiple types of illumination elements. It is also limited by the fixed length of the flexible extension.

Still, yet other such devices comprise a battery power source, a fixed length extension comprised of a flexible rod, and a lamp assembly of one type. The device does not permit multiple types of illumination elements. It is also limited by the fixed length of the flexible extension.

Even yet, other such devices comprise a hand-held body containing a battery power source, a fixed length extension pre-assembled from fixed length pieces, and a single type lamp assembly. The extension is covered with a tubular fixed length flexible sheath. In general, these disclosed devices provide a means for folding over and clamping the body with the illuminating element. The device does not permit multiple types of illumination elements. It is also limited by the fixed length of the flexible extension.

Yet even more, another such device, comprising a magnetic base flat bottom base with a fixed length flexible rod connected to a single type lamp assembly, is disclosed. Power is supplied through a connection with the vehicles power system usually an auto cigarette lighter socket. The device does not permit multiple types of illumination elements. It is also limited by the fixed length of the flexible extension.

Each of the disclosed devices lack one or more of the requirements. Some lack a flexible extension. All of these disclosed devices are limited to a fixed length extension. Still, others fix the illumination element with the extension. Others lack a mounting device. All of the elements comprising the disclose devices are limited to a single size. Lastly, none of the disclosed devices disclose interchangeable illuminating elements.

### SUMMARY OF THE INVENTION

The present invention provides a portable, flexible illuminating device. According to one aspect of the invention, this device includes a body with a portable power source, a flexible extension, and interchangeable illuminating elements. The interchangeable illuminating elements may include different types of lighting elements. In addition, the interchangeable illuminating elements may vary in size.

In another aspect, the invention comprises a mountable base element, a flexible extension, and interchangeable illuminating elements. The mountable base element may include interchangeable mounting brackets attached to the base element.

In still, another aspect, the invention consists of a body with an outside power source connection, a flexible extension, and an illuminating element. The illuminating device may be powered from either AC or DC electrical power. In this aspect, the intensity of the illumination element may be varied.

In still yet, another aspect, the invention consists of a body with interchangeable and expandable extension pieces.

### BRIEF DESCRIPTION OF THE DRAWINGS

FIG. 1 is a perspective view of one embodiment of a portable flexible illumination device of the present invention.

FIGS. 2A-2C are perspective views of multiple mounting brackets for use with a portable illumination device according to embodiments of the present invention.

FIGS. 3A-3B are perspective views of multiple types of extensions for use with a portable illumination device according to embodiments of the present invention.

FIG. 4 is a power system detail according to an embodiment of the present invention.

FIG. 5 is a detail of one type of flexible joint according to an embodiment of the present invention.

FIG. 6 is a detail view of an embodiment of an illumination element of the present invention.

### DETAILED DESCRIPTION

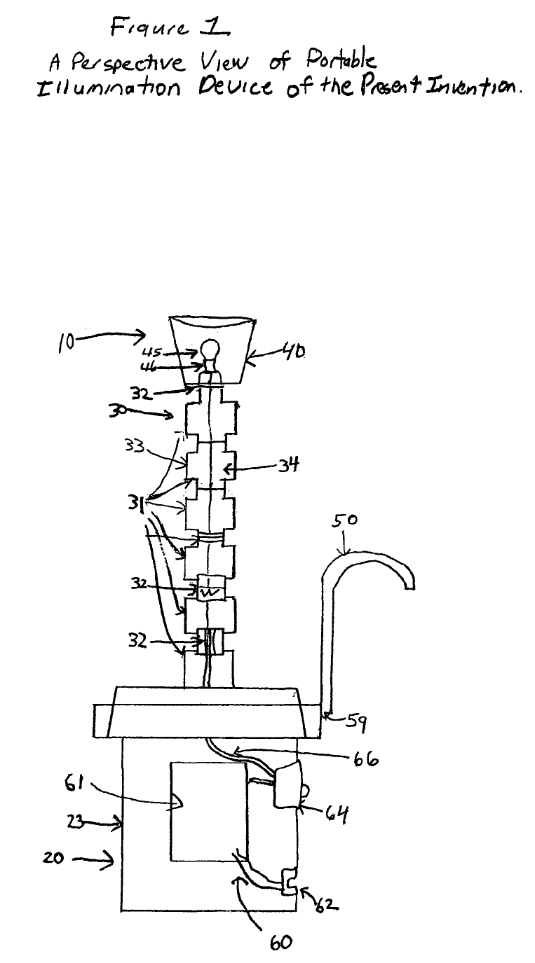

The present invention provides a device for improved local illumination of areas in need of repair or inspection. The illumination device 10 illustrated in FIG. 1 includes a body 20, an extension 30, an illumination element 40, a mounting bracket 50, and a power system 60. The exterior 23 of the body 20 may be of any shape and made of any non-electrical conducting material including: plastic, rubber or other material. Alternatively, the body may be of any material which is electrically insulated from the power system 60 and illumination element 40.

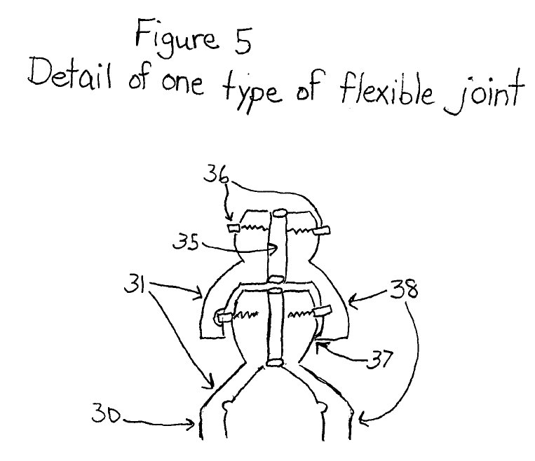

According to a preferred embodiment, illustrated in FIG. 1, the extension 30 is made of one or more extension pieces 31 with connectors 32A, 32′ at each end. The connectors 32A, 32′ may be of several types including: snap adapters, threaded adapters, or quick coupler adapters. Also,the type of connectors found in a set of extension pieces 31 generally are the same type so that they can be connected together. The exterior 33 of an extension piece 31 may be made of any non-electrical conducting material including: plastic, rubber, or other material or any material which is insulated from the power of the illumination device. The interior 34 of an extension piece 31 may be made of any suitable material including: metal, plastic, rubber, or other material. A connector 32A of an extension piece 31 connects with the body 20. In this embodiment, an interchangeable illumination element 40 is connected to the other end of the extension piece 31. In general, the term “interchangeable” with respect to the illumination element 40 means replaceable with different types of illumination elements. Although an extension piece 31 illustrated in FIG. 5 is cylindrical, other embodiments include extension pieces 31 made of any size and shape.

Although in this embodiment, the power source 61 is located inside the body 20, the power source may be housed in the illumination element in other embodiments. A power circuit 66, a power connector 62, and a power switch 64 are also shown in FIG. 1.

In the embodiment shown in FIG. 1, the mounting bracket 50 connects to the body 20 with a hinged type fastener 59.

As shown in FIG. 5, an extension 30 may be flexible. The flexible nature of a piece 31 made be from the natural attribute of the material or from a flexible joint 37 or any combination of the two means. Although preferably a piece is small enough to fit around the various sized spaces in-between the different pieces of equipment, a piece 31 may be of any length and size. In this aspect, a spring based clip 36 secures the joint connection. Also is this aspect, the lower end 38 of a piece 31 is made of a flexible material allowing the extension to bend. A hollow space 35 is left inside a piece 31.

In another embodiment, any type of connection 32A, 32′ may be mixed and matched respectively as long as 32A, 32′ are of compatible types.

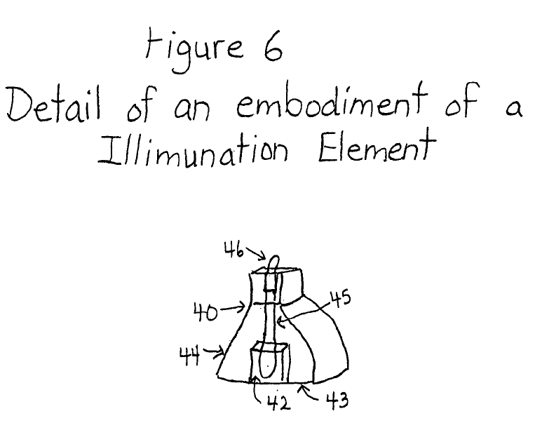

According to one embodiment of the illumination element illustrated in FIG. 6, an illumination element 40 consists of a housing 44, a lens 43, a conductive holder 46 attached with the housing 44, and an illuminating source 45 attached to the conductive holder 46, the illuminating source 45 being positioned in the inside part of the compartment 42. The illuminating source 45 may be any light emitting device such as one or more incandescent light bulb, an LED, neon light, florescent, halogen or other such device for producing illumination. The exterior of the housing 44 may be made of any non-electrical conducting material such as rubber, plastic or other material or any material which is insulated from the power of the illumination device 10. The inner portion of the housing 44 may be constructed of any suitable material or combination thereof of sufficient strength including: plastic, metal, rubber, or other material. The total size of the illuminating element 40 may be of any sufficient size to fit within the space between equipment.

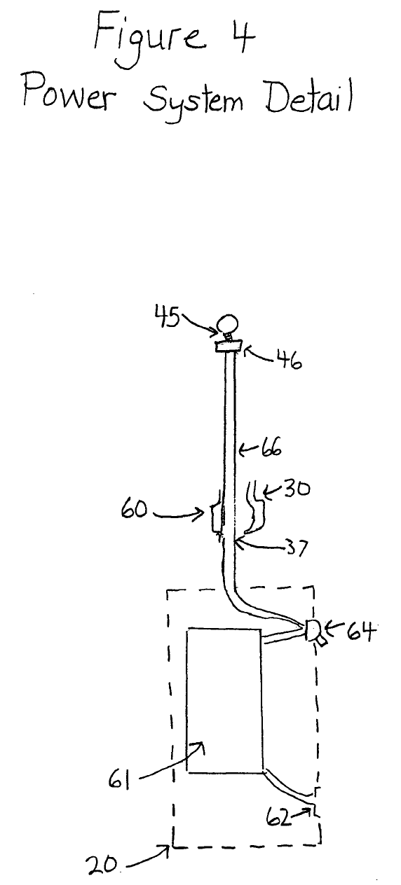

In an embodiment of the present invention as illustrated in FIG. 4, the power system 60 consists of a power source 61 located inside a cavity in the body 20, an electrical switch, a power circuit and an illuminating source 45. Generally, this power source 61 is portable consisting of rechargeable or traditional batteries. In other embodiments, this power source 61 may include an AC or DC power connector 62 with or with out a battery charger. The AC or DC power connector 62 electrically connects to the power source 61.

The power source 61 also connects electrically with a power on/off switch 64. The power switch 64 connects electrically with the power circuit 66. The power switch 64 may also vary the amount of power delivered to the power circuit 66. The power circuit 66 is inserted through the hollow portion 37 of the extension 30. The power circuit 66 electrically connects with the conductive holder 46. The illuminating source 45 attaches electrically with the conductive holder 46.

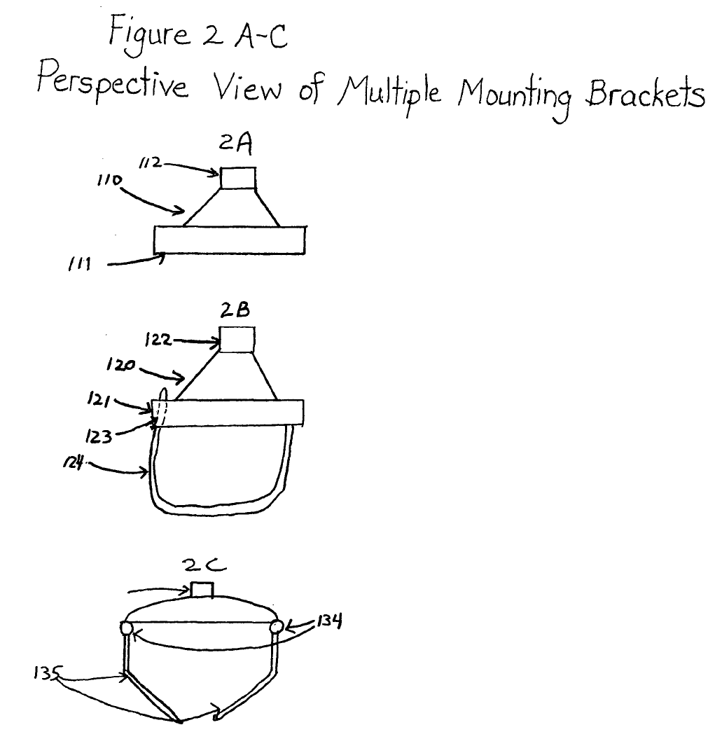

FIGS. 2A-2C illustrate multiple types of mounting brackets 50. FIG. 2A shows a magnet type mounting bracket 110. In FIG. 2A, a connector 112 attaches with sufficient strength to a body 111. The body 111 is magnetic. FIG. 2B shows a strap type mounting bracket 120. In FIG. 2B, the connector 122 attaches with sufficient strength to a body 121. The body 121 includes a strap 124 of sufficient strength made of any flexible material including: plastic, rubber, leather, or other material. FIG. 2C shows a clamp type mounting bracket 130. In FIG. 2C, the connector 132 attaches using a fastener 134 of sufficient strength to a body 131. The body 131 includes a clamp 135 of sufficient strength made from any material including: metallic, plastic, rubber, leather, or other material. The connectors 112, 122,132 may be of any known type including: snap adapters, threaded adapters, or quick coupler adapters. Of course, other types of mounting brackets could also be used.

Each of these mounting brackets may be attached either with a body 20 or an extension 30 via a connector 59 positioned as shown in FIG. 1. Although the mounting bracket 50 shown in FIG. 1 is a strap type mounting bracket, the present invention is not limited to this type of connector.

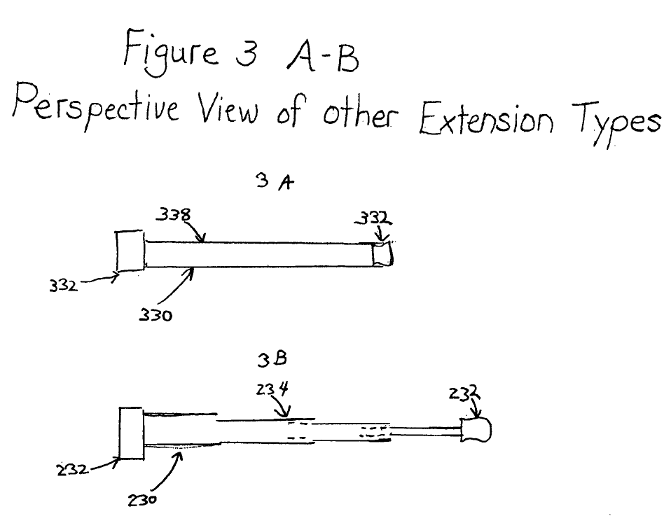

In other embodiments, illustrated in FIGS. 3A-3B, an extension 330 230 may be constructed differently including: a fixed rod as shown in FIG. 3A or a telescoping set of rods assembled together as shown in FIG. 3B. In FIG. 3A, the extension 330 consists of connectors 332A, 332′ at each end and a single component rod 338 made of any suitable non-electrical conducting material. The connector 332A, 332′ may be of any type including: snap adapters, threaded adapters, or quick coupler adapters. In FIG. 3B, the extension 230 consists of a connector 232A, 232′ at each end with telescoping inner connecting rods 234 made of any non-electrical conducting material. The connector 232A, 232′ may be of any type including: snap adapters, threaded adapters, or quick coupler adapters.

Having disclosed at least one embodiment of the present invention, various adaptations, modifications, additions, and improvements will be readily apparent to those of ordinary skill in the art. Such adaptations, modifications, additions and improvements are considered part of the invention which is only limited by the several claims attached hereto.

What is claimed is:

1. An illuminating device comprising:
a body,
an extension having a first end connected to the body,
a plurality of illumination elements, wherein each of the plurality of illumination elements are independently connectable to a second end of extension; and
a power source electrically coupleable to said illumination elements.

2. An illuminating device of claim 1 wherein the power source is located in said body and electrically coupled to the illumination elements through the extension.

3. The illuminating device of claim 2 wherein said power source includes a set of batteries.

4. The illuminating device of claim 1 wherein said extension is flexible.

5. The illuminating device of claim 1 wherein said extension includes a plurality connectable pieces.

6. The illuminating device of claim 1 wherein said power source includes an electrical power connection.

7. The illuminating device of claim 1 further comprising a mounting bracket attached to said body.

8. The illuminating device of claim 1 further comprising a mounting bracket attached to said extension.

9. The illuminating device of claim 1 wherein said power source deliveries a variable amount of electrical power to said illumination element.

10. An illuminating device comprising:
a body,
an extension having a first end connected to the body,
an illumination element connectable to a second end of extension; and
a power source electrically coupleable to said illumination element; and
wherein said extension includes a plurality of connectable pieces.

11. An illuminating device of claim 10 wherein the power source located in said body and electrically coupled to the illumination element through the extension.

12. The illuminating device of claim 10 wherein said power source includes a set of batteries.

13. The illuminating device of claim 10 wherein said extension is flexible.

14. The illuminating device of claim 10 wherein said power source includes an electrical power connection.

15. The illuminating device of claim 14 further comprising a mounting bracket attached to said body.

16. The illuminating device of claim 10 further comprising a mounting bracket attached to said extension.

17. The illuminating device of claim 10 wherein said power source deliveries a variable amount of electrical power to said illumination element.
